(19) United States
(12) Patent Application Publication
(10) Pub. No.: US 2024/0001555 A1
(43) Pub. Date: Jan. 4, 2024

(54) AUGMENTED REALITY DISPLAY DEVICE AND AUGMENTED REALITY DISPLAY SYSTEM

(71) Applicants: FANUC CORPORATION, Minamitsuru-gun, Yamanashi (JP); Hitachi, Ltd., Tokyo (JP)

(72) Inventors: Youhei NAKADA, Yamanashi (JP); Takeshi MOTODAKA, Tokyo (JP)

(21) Appl. No.: 18/038,808

(22) PCT Filed: Dec. 7, 2021
(86) PCT No.: PCT/JP2021/044866

§ 371 Date: May 25, 2023

(30) Foreign Application Priority Data
Dec. 14, 2020 (JP) 2020-206847

(51) Int. Cl. B25J 9/16; B25J 9/00; B25J 13/00; B25J 19/02; G06T 19/00

(52) U.S. Cl. CPC B25J 9/1671; B25J 9/1674; B25J 9/0081; B25J 13/006; B25J 19/023; G06T 19/006

(57) ABSTRACT

According to the present invention, the operating area of a robot is easily checked. This augmented reality display device comprises: a camera; a display unit; and a display control unit which displays, on the display unit, an image of a robot captured by the camera and an augmented reality image of the operating area of the robot.

### TECHNICAL FIELD

The present invention relates to an augmented reality display device and an augmented reality display system.

### BACKGROUND ART

In the case in which there is a possibility that an operator who is a safety monitoring target may enter a motion area of a robot, a technology is known in which the motion area of the robot is set around the operator, and when the robot enters the motion area, safety motion control, emergency stop control, and the like of the robot are performed. For example, see Patent Document 1.
Patent Document 1: Japanese Unexamined Patent Application, Publication No. 2004-243427

### DISCLOSURE OF THE INVENTION

### Problems to be Solved by the Invention

However, since the operator cannot visually recognize the motion area of the robot, the operator may erroneously enter the motion area and stop the robot. This lowers the working efficiency of the robot.

Therefore, it is desired to easily check the motion area of the robot.

### Means for Solving the Problems

(1) One aspect of the present disclosure is an augmented reality display device comprising: a camera; a display unit; and a display control unit configured to display, on the display unit, an image of a robot captured by the camera and an augmented reality image of a motion area of the robot.

(2) One aspect of the present disclosure is an augmented reality display system comprising: a robot; and the augmented reality display device according to (1).

### Effects of the Invention

According to one aspect, the motion area of the robot can be easily checked.

### BRIEF DESCRIPTION OF THE DRAWINGS

FIG. 1 is a functional block diagram showing a functional configuration example of an augmented reality display system according to an embodiment;

FIG. 2A shows an example of a motion program;

FIG. 2B shows an example of a list of target position coordinates taught in the motion program;

FIG. 3 shows an example of display of an augmented reality (AR) image of a motion area of a robot;

FIG. 4 shows an example of display of an AR image of a motion trajectory up to the next target position coordinates;

FIG. 5 shows an example of display of the AR image of the motion area of the robot and the AR image of the motion trajectory up to the next target position coordinates; and

FIG. 6 is a flowchart illustrating display processing of an augmented reality display device.

### PREFERRED MODE FOR CARRYING OUT THE INVENTION

### One Embodiment

An embodiment will now be described with reference to the drawings.

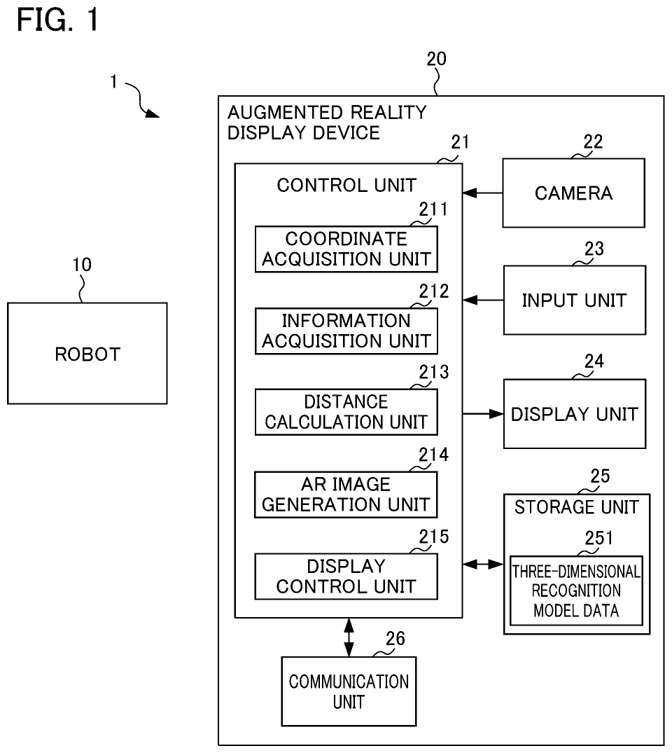

FIG. 1 is a functional block diagram showing a functional configuration example of an augmented reality display system according to the embodiment.

As shown in FIG. 1, an augmented reality display system 1 includes a robot 10 and an augmented reality display device 20.

### <Robot 10>

The robot 10 is, for example, an industrial robot known to those skilled in the art. The robot 10 drives a servo motor (not shown) disposed in each of a plurality of joint axes (not shown) included in the robot 10 based on a drive command from a robot control device (not shown), thereby driving a movable member (not shown) of the robot 10.

### <Augmented Reality Display Device 20>

The augmented reality display device 20 is, for example, a smartphone, a tablet terminal, an augmented reality (AR) glass, a mixed reality (MR) glass, or the like.

As shown in FIG. 1, the augmented reality display device 20 according to the present embodiment includes a control unit 21, a camera 22, an input unit 23, a display unit 24, a storage unit 25, and a communication unit 26. The control unit 21 includes a coordinate acquisition unit 211, an information acquisition unit 212, a distance calculation unit 213, an AR image generation unit 214, and a display control unit 215.

The camera 22 is, for example, a digital camera or the like, and captures an image of the robot 10 based on an operation of an operator, who is a user, and generates two-dimensional image data projected on a plane perpendicular to the optical axis of the camera 22. The image data generated by the camera 22 may be a visible light image such as an RGB color image.

The input unit 23 is, for example, a touch panel (not shown) or the like disposed on the display unit 24 described later, and receives an input operation from an operator who is a user.

The display unit 24 is, for example, a liquid crystal display (LCD) or the like. The display unit 24 displays an image of the robot 10 captured by the camera 22 and an augmented reality image (AR image) of a motion area of the robot 10 acquired from a robot control device (not shown) by the information acquisition unit 212 described later via the communication unit 26 described later, based on a control command of the display control unit 215 described later.

The storage unit 25 is, for example, a ROM (read only memory), an HDD (hard disk drive), or the like, and stores, for example, a system program and an augmented reality display application program that are executed by the control unit 21 described later. The storage unit 25 may store three-dimensional recognition model data 251.

With regard to the three-dimensional recognition model data 251, for example, the posture and orientation of the robot 10 are changed beforehand, and feature quantities such as edge quantities extracted from a plurality of images of the robot 10 captured by the camera 22 at various distances and angles (inclinations) are stored as three-dimensional recognition models. With regard to the three-dimensional recognition model data 251, the three-dimensional coordinates of the origin (hereinafter also referred to as “robot origin”) of the robot coordinate system of the robot 10 in the world coordinate system when an image of each three-dimensional recognition model is captured, and information indicating the directions of the X-axis, the Y-axis, and the Z-axis of the robot coordinate system in the world coordinate system at that time may be stored in association with the corresponding three-dimensional recognition model.

The origin and the directions of the X-axis, the Y-axis, and the Z-axis of the world coordinate system are defined so as to coincide with the position of the augmented reality display device 20 when the augmented reality display device 20 executes the augmented reality display application program described above, that is, the origin and the directions of the X-axis, the Y-axis, and the Z-axis of the camera coordinate system of the camera 22. When the augmented reality display device 20 (camera 22) moves after executing the augmented reality display application program, the origin in the camera coordinate system moves from the origin in the world coordinate system.

The communication unit 26 is a communication control device that transmits and receives data to and from a network such as a wireless LAN (local area network), Wi-Fi (registered trademark), and a mobile phone network conforming to standards such as 4G and 5G. The communication unit 26 may communicate with a robot control device (not shown) for controlling the motion of the robot 10, as an external device.

### <Control Unit 21>

The control device 21 includes a CPU (central processing unit), ROM, RAM, CMOS (complementary metal-oxide-semiconductor) memory, and the like, which are configured to communicate with each other via a bus and are known to those skilled in the art.

The CPU is a processor that controls the entire augmented reality display device 20. The CPU reads the system program and the augmented reality display application program stored in the ROM via the bus, and controls the entire augmented reality display device 20 in accordance with the system program and the augmented reality display application program. Thereby, as shown in FIG. 1, the control unit 21 is configured to realize functions of the coordinate acquisition unit 211, the information acquisition unit 212, the distance calculation unit 213, the AR image generation unit 214, and the display control unit 215. The RAM stores a variety of data such as temporary calculation data and display data. The CMOS memory is backed up by a battery (not shown), and is configured as a non-volatile memory in which a storage state is held even when the power of the augmented reality display device 20 is turned off.

### <Coordinate Acquisition Unit 211>

The coordinate acquisition unit 211, for example, acquires the three-dimensional coordinates of the robot origin in the world coordinate system based on an image of the robot captured by the camera 22.

Specifically, the coordinate acquisition unit 211 extracts feature quantities such as edge quantities from an image of the robot 10 captured by the camera 22 using, for example, a known robot three-dimensional coordinate recognition method (for example, https://linx.jp/product/mvtec/halcon/feature/3d_vision.html). The coordinate acquisition unit 211 performs matching between the extracted feature quantities and the feature quantities of the three-dimensional recognition models stored in the three-dimensional recognition model data 251. The coordinate acquisition unit 211, for example, acquires the three-dimensional coordinates of the robot origin and information indicating the directions of the X-axis, the Y-axis, and the Z-axis of the robot coordinates of the three-dimensional recognition model having the highest degree of match based on the matching results.

The coordinate acquisition unit 211 acquired the three-dimensional coordinates of the robot origin and information indicating the directions of the X-axis, the Y-axis, and the Z-axis of the robot coordinates in the world coordinate system by using the robot three-dimensional coordinate recognition method, but the present invention is not limited thereto. For example, the coordinate acquisition unit 211 may attach a marker such as a checkerboard to the robot 10, and may acquire the three-dimensional coordinates of the robot origin and information indicating the directions of the X-axis, the Y-axis, and the Z-axis of the robot coordinates in the world coordinate system from an image of the marker captured by the camera 22 based on known marker recognition technology.

Alternatively, an indoor positioning device such as an ultra wide band (UWB) may be attached to the robot 10, and the coordinate acquisition unit 211 may acquire the three-dimensional coordinates of the robot origin and information indicating the directions of the X-axis, the Y-axis, and the Z-axis of the robot coordinates in the world coordinate system from the indoor positioning device.

### <Information Acquisition Unit 212>

The information acquisition unit 212, for example, acquires the three-dimensional coordinates (hereinafter, also referred to as “three-dimensional coordinates of the camera 22”) of the origin of the camera coordinate system of the camera 22 in the world coordinate system based on a signal from a sensor (not shown) such as a GPS sensor or an electronic gyro included in the augmented reality display device 20.

The information acquisition unit 212 may query the robot control device (not shown) via the communication unit 26 and may acquire setting information indicating a motion area of the robot 10 from the robot control device (not shown). The motion area of the robot 10 is an area through which part of the robot 10 and all of the robot 10 can pass, and is defined in advance in the robot coordinate system. Therefore, the AR image generation unit 214 described later converts the setting information of the motion area of the robot 10 into the world coordinate system based on the three-dimensional coordinates of the robot origin and the directions of the X-axis, the Y-axis, and the Z-axis of the robot coordinates in the world coordinate system.

The information acquisition unit 212 may acquire the setting information of the motion area of the robot 10 in accordance with an input operation of the operator via the input unit 23.

The information acquisition unit 212 may query the robot control device (not shown) via the communication unit 26 and may acquire from the robot control device (not shown) at least the next target position coordinates taught in a motion program being executed.

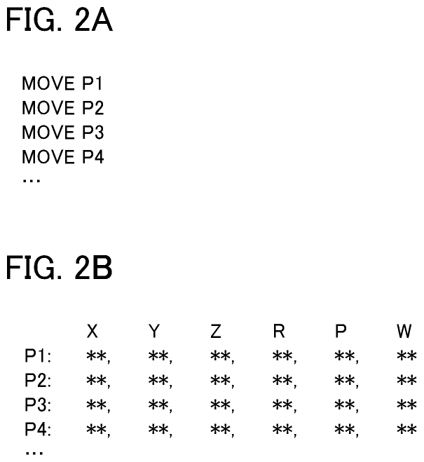

FIG. 2A shows an example of the motion program. FIG. 2B shows an example of a list of target position coordinates taught in the motion program.

For example, when the information acquisition unit 212 queries the robot control device (not shown) about the next target position coordinates, if the block “MOVE P2” of the program in FIG. 2A is being executed, the robot control device (not shown) reads the coordinates of the target position P3 of the next block “MOVE P3” from the list of FIG. 2B Thereby, the information acquisition unit 212 acquires the coordinates of a target position P3 as the next target position coordinates from the robot control device (not shown).

The coordinates of target positions P1 to P4 in FIG. 2B include components of the X coordinate, the Y coordinate, the Z coordinate, the rotation angle R around the X axis, the rotation angle P around the Y axis, and the rotation angle W around the Z axis in the robot coordinate system.

### <Distance Calculation Unit 213>

The distance calculation unit 213 calculates the distance between the robot 10 and the augmented reality display device based on the three-dimensional coordinates of the robot origin in the world coordinate system acquired by the coordinate acquisition unit 211 and the three-dimensional coordinates of the camera 22 in the world coordinate system acquired by the information acquisition unit 212.

### <AR Image Generation Unit 214>

The AR image generation unit 214, for example, sequentially generates an AR image of a motion area of the robot 10 and an AR image of a motion trajectory up to the next target position coordinates based on the three-dimensional coordinates of the robot origin of the robot 10, the directions of the X-axis, Y-axis, and Z-axis of the robot coordinates, the three-dimensional coordinates of the camera 22, the setting information indicating the motion area of the robot 10, and the next target position coordinates of the robot 10.

Specifically, the AR image generation unit 214, for example, converts the setting information of the motion area of the robot 10 from the robot coordinate system into the world coordinate system based on the three-dimensional coordinates of the robot origin of the robot 10 and the directions of the X-axis, the Y-axis, and the Z-axis of the robot coordinates in the world coordinate system, and generates an AR image of the motion area of the robot 10.

Further, the AR image generation unit 214, for example, converts the next target position coordinates of the robot 10 from the robot coordinate system into the world coordinate system based on the three-dimensional coordinates of the robot origin of the robot 10 and the directions of the X-axis, the Y-axis, and the Z-axis of the robot coordinates in the world coordinate system, and generates an AR image of a motion trajectory up to the next target position coordinates of the robot 10.

### <Display Control Unit 215>

The display control unit 215, for example, displays, on the display unit 24, an image of the robot 10 captured by the camera 22 and an AR image of a motion area of the robot 10 generated by the AR image generation unit 214.

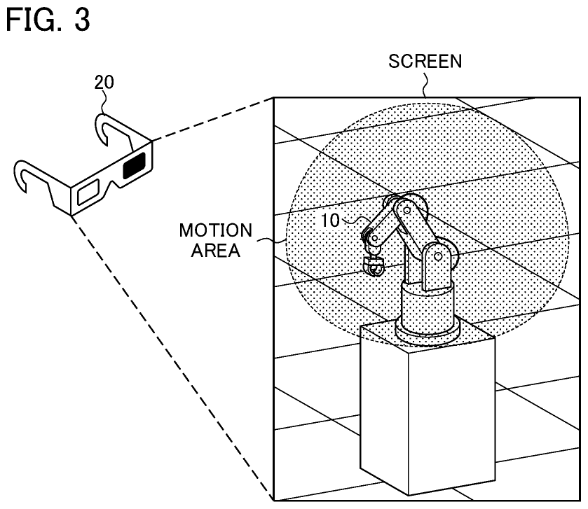

FIG. 3 shows an example of display of an AR image of a motion area of the robot 10.

As shown in FIG. 3, the display control unit 215, for example, adjusts the position and posture in the AR image generated by the AR image generation unit 214 with respect to the robot origin in the world coordinate system acquired by the information acquisition unit 212, based on the world coordinate system, and superimposes the image of the robot 10 captured by the camera 22 on the AR image of the motion area of the robot 10 and displays the superimposed image.

The display control unit 215 may change the display form of the AR image of the motion area of the robot 10 based on the distance between the robot 10 and the augmented reality display device 20 calculated by the distance calculation unit 213. For example, in a case in which a distance α that is away from the robot 10 and is a safe distance and a distance β (β<α) that is close to the robot 10 and is a risky distance are set in advance by the user such as the operator, the display control unit 215 may display the AR image of the motion area of the robot 10 in blue to indicate that it is safe when the distance between the robot 10 and the augmented reality display device 20 is greater than or equal to the distance α. When the distance between the robot 10 and the augmented reality display device 20 is greater than or equal to the distance β and less than the distance α, the display control unit 215 may display the AR image of the motion area of the robot 10 in yellow to indicate that the robot 10 is close to the augmented reality display device 20. When the distance between the robot 10 and the augmented reality display device is less than the distance β, the display control unit 215 may display the AR image of the motion area of the robot 10 in red to indicate that the augmented reality display device 20 is close to the robot 10 and it is risky.

This can prevent the operator from accidentally entering the motion area of the robot 10.

The display control unit 215, for example, may superimpose the image of the robot 10 captured by the camera 22 on the AR image of the motion trajectory up to the next target position coordinates generated by the AR image generation unit 214, and may display the superimposed image on the display unit 24.

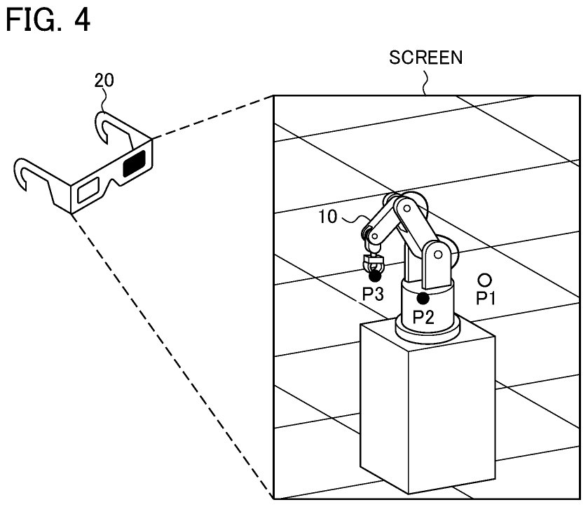

FIG. 4 shows an example of display of the AR image of the motion trajectory up to the next target position coordinates.

As shown in FIG. 4, the display control unit 215 displays the current target position P2 and the next target position P3 of the robot 10. Thereby, the operator can predict the next motion of the robot 10 and avoid collision with the robot 10.

The display control unit 215 may also display the coordinates of the past target position P1. In this case, the coordinates of the target position P1 are preferably displayed in a color or shape different from that of the coordinates of the target positions P2 and P3.

The display control unit 215, for example, may superimpose the image of the robot 10 captured by the camera 22, the AR image of the motion area of the robot 10 generated by the AR image generation unit 214, and the AR image of the motion trajectory up to the next target position coordinates, and may display the superimposed image on the display unit 24.

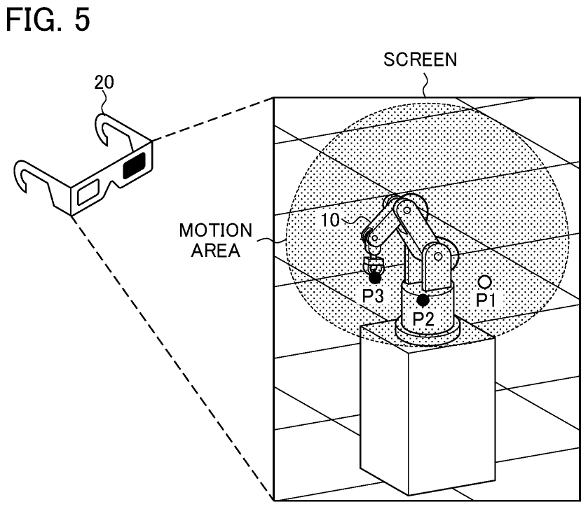

FIG. 5 shows an example of display of the AR image of the motion area of the robot 10 and the AR image of the motion trajectory up to the next target position coordinates.

### <Display Processing of Augmented Reality Display Device 20>

Next, operations related to the display processing of the augmented reality display device 20 according to the embodiment will be described.

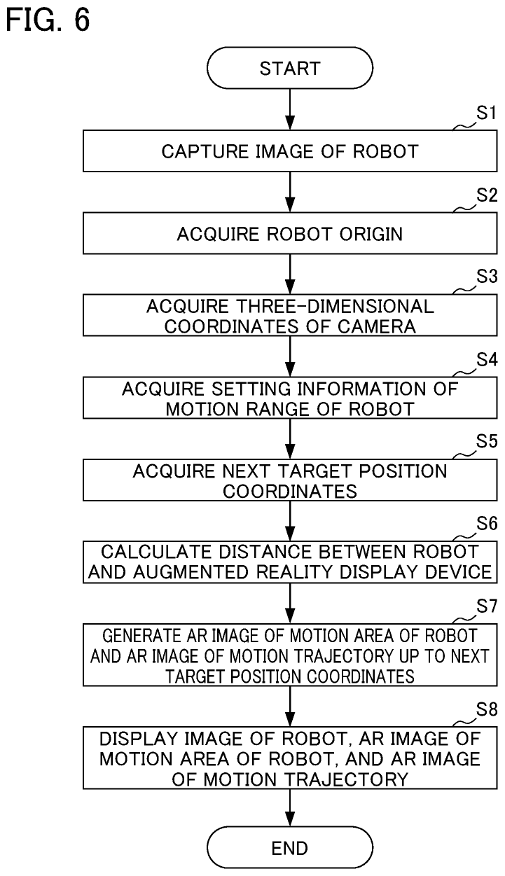

FIG. 6 is a flowchart illustrating display processing of the augmented reality display device 20. The flow shown here is repeatedly executed while the display processing is performed.

In Step S1, the camera 22 captures an image of the robot 10 based on an instruction from the operator via the input unit 23.

In Step S2, the coordinate acquisition unit 211 acquires information indicating the three-dimensional coordinates of the robot origin in the world coordinate system and information indicating the directions of the X-axis, the Y-axis, and the Z-axis of the robot coordinates in the world coordinate system, based on the image of the robot 10 captured in Step S1 and the three-dimensional recognition model data 251.

In Step S3, the information acquisition unit 212 acquires the three-dimensional coordinates of the camera 22 in the world coordinate system.

In Step S4, the information acquisition unit 212 queries the robot control device (not shown) via the communication unit 26, and acquires, from the robot control device (not shown), the setting information of the motion area of the robot 10.

In Step S5, the information acquisition unit 212 queries the robot control device (not shown) via the communication unit 26, and acquires, from the robot control device (not shown), at least the next target position coordinates taught in the motion program being executed.

In Step S6, the distance calculation unit 213 calculates the distance between the robot 10 and the augmented reality display device 20 based on the three-dimensional coordinates of the robot origin in the world coordinate system acquired in Step S2 and the three-dimensional coordinates of the camera 22 in the world coordinate system acquired in Step S3.

In Step S7, the AR image generation unit 214 generates an AR image of the motion area of the robot 10 and an AR image of the motion trajectory up to the next target position coordinates based on the three-dimensional coordinates of the robot origin of the robot 10, the directions of the X-axis, the Y-axis, and the Z-axis of the robot coordinates, the three-dimensional coordinates of the camera 22, the setting information indicating the motion area of the robot 10, and the next target position coordinates of the robot 10.

In Step S8, the display control unit 215 displays, on the display unit 24, the image of the robot 10 captured in Step S1, the AR image of the motion area of the robot 10 generated in Step S7, and the AR image of the motion trajectory up to the next target position coordinates.

The processing of Steps S2 to S5 may be performed chronologically in sequence, or may be performed in parallel.

As described above, according to the augmented reality display device 20 of the embodiment, the motion area of the robot 10 can be easily checked by visualizing the motion area of the robot 10 by way of augmented reality display. As a result, the augmented reality display device 20 can prevent the operator from accidentally entering the motion area, and can improve work safety while ensuring high work efficiency.

Although one embodiment has been described above, the present invention is not limited to the above-described embodiment, and includes modifications, improvements, and the like within the scope of achieving the object.

### <Modification 1>

In the above-described embodiment, the augmented reality display device 20 displays the AR image of the motion area of the robot 10 such that the color changes according to the distance from the robot 10, but the present invention is not limited thereto. For example, the augmented reality display device 20 may display, on the display unit 24, the AR image of the motion area of the robot 10 and a message such as “Approaching the motion area of the robot” depending on the distance from the robot 10.

Alternatively, the augmented reality display device 20 may display the AR image of the motion area of the robot 10 on the display unit 24, and may output a message such as “Approaching the motion area of the robot” or an alarm sound from a speaker (not shown) included in the augmented reality display device 20 depending on the distance from the robot 10.

### <Modification 2>

For example, in the above-described embodiment, the augmented reality display device 20 associates the three-dimensional coordinates of the camera 22 with the world coordinate system when the augmented reality display application program is executed, but the present invention is not limited thereto. For example, the augmented reality display device 20 may obtain the three-dimensional coordinates of the camera 22 in the world coordinate system using a known self-position estimation method.

### <Modification 3>

For example, in the above-described embodiment, the augmented reality display device 20 acquires the next target position coordinates from the robot control device (not shown), but may acquire all the target position coordinates.

Each function included in the augmented reality display device 20 according to the embodiment can be realized by hardware, software, or a combination of these. Here, “realized by software” means that it is realized by a computer reading and executing a program.

The program may be stored and provided to the computer using various types of non-transitory computer readable media. The non-transitory computer readable media include various types of tangible storage media. Examples of the non-transitory computer-readable media include magnetic recording media (e.g., flexible disks, magnetic tapes, and hard disk drives), magneto-optical recording media (e.g., magneto-optical disks), CD-ROMs (read only memories), CD-Rs, CD-R/Ws, semiconductor memories (e.g., mask ROMs, PROMs (programmable ROMs), EPROMs (erasable PROMs), flash ROMs, and RAMs). The program may be provided to the computer with various types of transitory computer readable media. Examples of the transitory computer readable media include electrical signals, optical signals, and electromagnetic waves. The transitory computer readable media can supply the program to the computer via a wired communication path, such as an electric wire or an optical fiber, or a wireless communication path.

Note that the step of describing the program recorded in the recording medium includes not only the processing performed chronologically in sequence but also the processing performed in parallel or individually without necessarily being processed chronologically.

In other words, the augmented reality display device and the augmented reality display system of the present disclosure can take various embodiments having the following features.

(1) An augmented reality display device 20 of the present disclosure is an augmented reality display device including a camera 22, a display unit 24, and a display control unit 215 configured to display, on the display unit 24, an image of a robot 10 captured by the camera 22 and an augmented reality image of a motion area of the robot 10.

According to the augmented reality display device 20, the motion area of the robot can be easily checked.

(2) The augmented reality display device 20 according to (1) may include a coordinate acquisition unit 211 configured to acquire three-dimensional coordinates of a robot origin based on the image of the robot 10 captured by the camera 22, and the display control unit 215 may arrange the augmented reality image of the motion area of the robot on the image of the robot with respect to the acquired robot origin and may display the image on the display unit 24.

Thus, the augmented reality display device 20 can associate the actual motion area of the robot 10 with the motion area of the AR image.

(3) The augmented reality display device 20 according to (1) or (2) may include an information acquisition unit 212 that acquires three-dimensional coordinates of the camera 22, and a distance calculation unit 213 that calculates a distance between the robot 10 and the augmented reality display device based on the three-dimensional coordinates of the robot origin and the three-dimensional coordinates of the camera 22, and the display control unit 215 may be configured to change a display form of the motion area of the robot according to the calculated distance.

Thus, the augmented reality display device 20 can prevent the operator from accidentally entering the motion area of the robot 10.

(4) The augmented reality display device 20 according to (3) may include a communication unit 26 that communicates with an external device, and the information acquisition unit 212 may acquire setting information indicating the motion area of the robot 10 from a robot control device.

Thus, the augmented reality display device 20 can acquire accurate setting information of the motion area of the robot 10.

(5) The augmented reality display device 20 according to (3) or (4) may include an input unit 23 that receives an input from a user, and the information acquisition unit 212 may acquire setting information indicating the motion area of the robot 10 from the user via the input unit 23.

Thus, the augmented reality display device 20 can acquire any setting information, desired by the user, of the motion area of the robot 10.

(6) In the augmented reality display device 20 according to any one of (3) to (5), the information acquisition unit 212 may acquire at least next target position coordinates of the robot 10, and the display control unit 215 may display, on the display unit 24, an augmented reality image of a motion trajectory up to the next target position coordinates together with the augmented reality image of the motion area of the robot 10.

Thus, the augmented reality display device 20 can predict the next motion of the robot 10, which can avoid collision between the robot 10 and the operator.

(7) An augmented reality display system 1 of the present disclosure is an augmented reality display system including a robot 10, and the augmented reality display device 20 according to any one of (1) to (6).

The augmented reality display system 1 can achieve the same effects as those of the first to sixth aspects.

### EXPLANATION OF REFERENCE NUMERALS

1 Augmented reality display system
10 Robot
20 Augmented reality display device
21 Control unit
211 Coordinate acquisition unit
212 Information acquisition unit
213 Distance calculation unit
214 AR image generation unit
215 Display control unit
22 Camera
23 Input unit
24 Display unit
25 Storage unit
251 Three-dimensional recognition model data
26 Communication unit

1. An augmented reality display device, comprising:
a camera;
a display unit; and
a display control unit configured to display, on the display unit, an image of a robot captured by the camera and an augmented reality image of a motion area of the robot.

2. The augmented reality display device according to claim 1, comprising
a coordinate acquisition unit configured to acquire three-dimensional coordinates of a robot origin based on the image of the robot captured by the camera,
wherein the display control unit arranges the augmented reality image of the motion area of the robot on the image of the robot with respect to the acquired robot origin and displays the image on the display unit.

3. The augmented reality display device according to claim 2, comprising:
an information acquisition unit configured to acquire three-dimensional coordinates of the camera; and
a distance calculation unit configured to calculate a distance between the robot and the augmented reality display device based on the three-dimensional coordinates of the robot origin and the three-dimensional coordinates of the camera,
wherein the display control unit changes a display form of the motion area of the robot according to the calculated distance.

4. The augmented reality display device according to claim 3, comprising
a communication unit configured to communicate with an external device,
wherein the information acquisition unit acquires setting information indicating the motion area of the robot from the external device.

5. The augmented reality display device according to claim 3, comprising
an input unit configured to receive an input from a user,
wherein the information acquisition unit acquires setting information indicating the motion area of the robot from the user via the input unit.

6. The augmented reality display device according to claim 3,
wherein the information acquisition unit acquires at least next target position coordinates of the robot, and
wherein the display control unit displays, on the display unit, an augmented reality image of a motion trajectory up to the next target position coordinates together with the augmented reality image of the motion area of the robot.

7. An augmented reality display system, comprising:
a robot; and
the augmented reality display device according to claim 1.
